(19) United States
(12) Patent Application Publication
(10) Pub. No.: US 2012/0287544 A1
(43) Pub. Date: Nov. 15, 2012

(54) ISOLATION-TYPE AC FAULT CURRENT LIMITED CIRCUIT

(76) Inventor: Jui-Kun HUANG, Kaohsiung City (TW)

(21) Appl. No.: 13/107,089

(22) Filed: May 13, 2011

(51) Int. Cl. H02H 9/02

(52) U.S. Cl. 361/93.6

(57) ABSTRACT

An isolation-type AC fault current limited circuit is a current regulation circuit including a transformer and a conduction circuit. The transformer includes a primary winding coupled in series between a power supply input system and a load output system, and a secondary winding sharing a common iron core with the primary winding and electrically isolated therewith. The conduction circuit is connected to the secondary winding and includes a switch and a breaking element coupled in series. In the event that short circuit takes place on the power system, the breaking element induces great short circuit current of the primary winding and is fused to cut off conduction, so that the transformer becomes an open circuit to increase magnetizing reactance with high impedance to increase equivalent internal impedance of the power supply input system to limit fault current and allow circuit breaking devices of the power system to isolate short circuit.

### FIELD OF THE INVENTION

The present invention relates to an isolation-type AC fault current limited circuit and particularly to a short circuit fault current limited circuit electrically isolated from an AC power system.

### BACKGROUND OF THE INVENTION

A great deal of progress has been made on industrial power distribution systems. However, short circuit or malfunction caused by machine or circuit insulation defects, lightning strike, switch surge, human errors or the like still cannot be fully prevented, even if technology continuously advances in the future. When the malfunction takes place, a huge short circuit current is generated, and protection equipment has to rapidly isolate the malfunctioned machine or circuit to prevent the short circuit current continuously flowing to reduce equipment damage or power failure area of the power system.

Circuit breaking devices (such as circuit breakers or fuses) have been employed to isolate short circuit current in conventional techniques. However, if the short circuit current is too large and the arc suppression capacity of the circuit breaking device is inadequate, the electric arc cannot be fully eliminated and the short circuit current cannot be isolated, the circuit breaking device receives excessive current over its load and results in an explosion, and seriously endangers safety of using electricity. Hence the amount of the short circuit current of each bus circuit has to be calculated in advance to select adequate circuit breaking device with sufficient arc suppression capacity.

However, with increase of upstream power supply circuits and power generating sets and explosion of load circuits, fault current caused by short circuit of the existing power supply circuits also increases. This impacts operation safety of the circuit breaking devices and power supply equipment. To replace existing circuit breaking devices has practical difficulty and high investment concern. To make planning and design for new power supply equipment, such as adopting circuit breaking devices with greater capacity, also needs higher investment. Moreover, the conventional improved approach is to add inductors coupled in series in the power system to limit the fault current. But the inductors could additionally cause a problem of unstable voltage during power supply process.

### SUMMARY OF THE INVENTION

The primary object of the present invention is to provide an isolation-type AC fault current limited circuit to overcome the problems of unstable voltage occurred to conventional power systems using merely inductors to limit fault current during operation and also no electrical isolation.

To achieve the foregoing object, the present invention employs a technique as follows:

Provide a current regulation circuit which includes a transformer, a maintenance bypass and at least one conduction circuit. The transformer includes a primary winding coupled in series between a power supply input system and a load output system, and a secondary winding sharing a common iron core with the primary winding and electrically isolated from the primary winding. The maintenance bypass includes two conduction switches and a bypass switch. The conduction switches are located respectively at a connection terminal of the primary winding and the power supply input system and another connection terminal of the primary winding and the load output system to control power supply operation of the transformer. The bypass switch has one end connected to the power supply input system in front of the conduction switch and another end connected to the load output system behind the other conduction switch, thus the power supply input system can directly supply electric power to the load output system to provide a bypass effect during maintenance. The conduction circuit is connected to the secondary winding and includes a switch and a breaking element coupled in series. When in use, the switch of the conduction circuit is set ON, and the transformer is converted into a short circuit operation mode to allow the power supply input system to supply electric power to the load output system through the transformer with low impedance. However, in the event that short circuit takes place on the load output system and a short circuit current is generated on the power system, the breaking element of the conduction circuit induces the great short circuit current of the primary winding and is fused to cut off conduction, hence the transformer becomes an open circuit to provide magnetizing reactance with high impedance to increase equivalent internal impedance of the power supply input system to limit fault current, and circuit breaking devices can smoothly isolate the short circuit. The secondary winding can further be connected to a plurality of conduction circuits. After the short circuit is eliminated, setting the switch of one of the conduction circuits ON to make the equivalent internal impedance of the power supply input system return to the normal condition without affecting power supply quality. According to the invention, when there is a need to replace a broken breaking element, first, set the bypass switch ON so that the power supply input system can directly supply electric power to the load output system; then set the two conduction switches OFF to cut off the power supply. When replacement of the breaking element is finished, the two conduction switches can be set ON again and the bypass switch is set OFF so that the short circuit condition of the transformer during the replacement process of the elements does not affect power usage of the load output system.

The current regulation circuit of the invention may adopt another structure, in which the conduction circuit consists of a plurality of conduction elements coupled in series. When the conduction elements are set ON and the current regulation circuit detects a great current, the conduction elements are set OFF. Only one of the conduction elements is set OFF the conduction circuit is cut off. The secondary winding also can be connected to a plurality of conduction circuits. After the short circuit incident is eliminated, backup conduction elements can be set ON again to avoid failure of the conduction circuits caused by malfunction of a single conduction element.

The invention provides an improvement over the conventional power system that reduces fault current by coupling inductors in series but generates unstable voltage. Through the primary winding and secondary winding of the transformer converted into a short circuit operation mode, the power supply input system provides voltage output to the load output system in regular conditions through the transformer with low impedance without affecting power supply stability. In the event that short circuit takes place and a great current is generated, the conduction circuit is cut off automatically so that the transformer becomes an open circuit to provide magnetizing reactance with higher impedance to increase the equivalent internal impedance of the power supply input system to limit fault current.

The invention is an isolation-type AC fault current limited circuit to cut off the conduction circuit when a short circuit occurs so that the transformer of the current regulation circuit generates magnetizing reactance with high impedance to increase the equivalent internal impedance of the power supply input system. Moreover, the primary winding and secondary winding of the transformer are electrically isolated to isolate noises such as switching surges of power supply to avert the switching surges of the primary winding from affecting normal operation of the conduction circuit elements. The secondary winding may contain more number of windings than that of the primary winding so that current flowing through the secondary winding is smaller than that of the primary winding, thereby the breaking element or conduction element with smaller capacity can be selected to set OFF or ON to reduce the cost.

In short, the isolation-type AC fault current limited circuit of the invention can provide benefits as follows:

1. The primary winding and secondary winding of the transformer are electrically isolated to isolate noises of power supply to avert the switching surges of the primary winding from affecting normal operation of the conduction circuit elements.

2. The current regulation circuit can generate magnetizing reactance to increase the equivalent internal impedance of the power supply input system to effectively limit short circuit current and allow the circuit breaking devices to exactly isolate the short circuit incident.

3. The secondary winding may contain more number of windings than that of the primary winding so that current flowing through the secondary winding is smaller than that of the primary winding, thereby the breaking element with smaller capacity can be selected.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit diagram showing a simplified single-phase equivalent circuit of the isolation-type AC fault current limited circuit of the invention.

FIG. 2 is a circuit diagram of the invention with a plurality of conduction circuits coupled in series.

FIG. 3 is a circuit diagram of another embodiment of the invention.

FIG. 4 is a circuit diagram of another embodiment of the invention with a plurality of conduction circuits coupled in series.

FIG. 5 is a simplified circuit diagram of another embodiment of the invention.

FIG. 6 is a circuit diagram showing replacement of a breaking element of the invention.

FIG. 7 is a circuit diagram of another embodiment showing replacement of a breaking element of the invention.

### DETAILED DESCRIPTION OF THE PREFERRED EMBODIMENTS

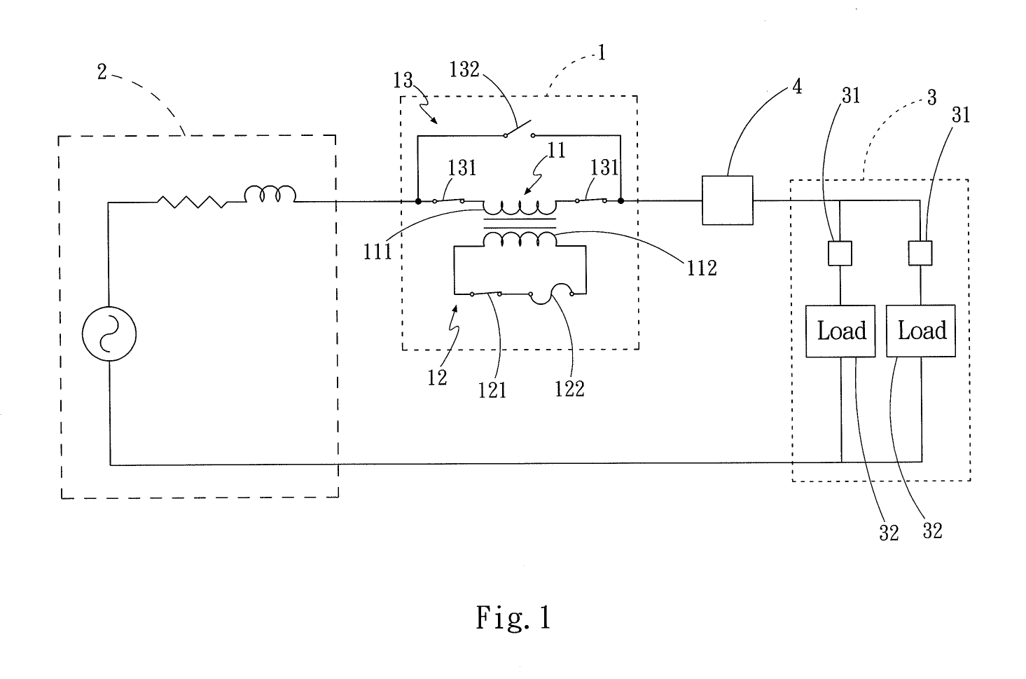

Please refer to FIG. 1, the present invention aims to provide an isolation-type AC fault current limited circuit which is a current regulation circuit 1 comprising a transformer 11, a maintenance bypass 13 and a conduction circuit 12.

The transformer 11 includes a primary winding 111 and a secondary winding 112. The primary winding 111 coupled in series between a power supply input system 2 and a load output system 3. The secondary winding 112 shares a common iron core with the primary winding 111 and is electrically isolated from the primary winding 111.

The maintenance bypass 13 includes two conduction switches 131 and a bypass switch 132. The two conduction switches 131 are located respectively at a connection terminal of the primary winding 111 and the power supply input system 2, and another connection terminal of the primary winding 111 and the load output system 3 to control power supply operation of the transformer 11. The bypass switch 132 has one end connected to the power supply input system 2 in front of the conduction switch 131 and another end connected to the load output system 3 behind the other conduction switch 131, thus the power supply input system 2 can directly supply electric power to the load output system 3 to provide a bypass effect during maintenance.

The conduction circuit 12 is connected to the secondary winding 112 and includes a switch 121 and a breaking element 122 coupled in series. The breaking element 122 can be a fuse.

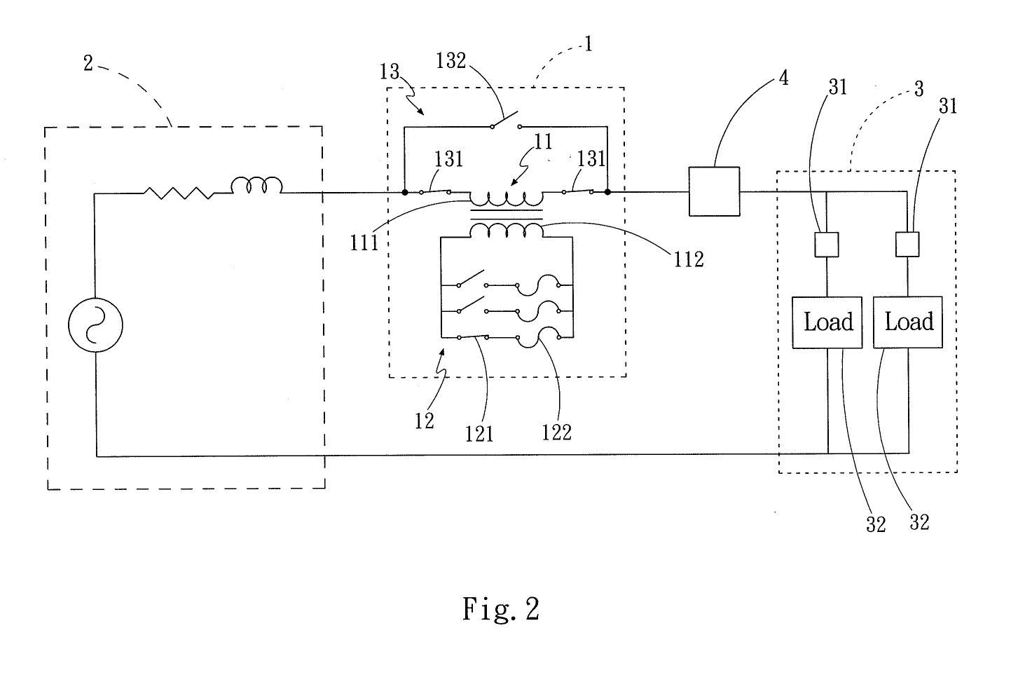

When the invention is in normal operation, the switch 121 of the conduction circuit 12 is set ON, and the transformer 11 is converted into a short circuit operation mode to allow the power supply input system 2 to supply electric power to the load output system 3 through the transformer 11 with low impedance. A circuit breaking device 4 connected to one side of the current regulation circuit 1 also is set ON to supply electric power normally without affecting power supply stability. However, in the event that short circuit takes place on the load output system 3 and a short circuit current is generated on the power system, the breaking element 122 of the conduction circuit 12 induces a great short circuit current of the primary winding 111 and is fused to cut off conduction, thus the transformer 11 becomes an open circuit to provide magnetizing reactance with high impedance to increase equivalent internal impedance of the power supply input system 2 to limit fault current, and the circuit breaking device 4 can smoothly isolate the short circuit. Another circuit breaking device 31 in the load output system 3 also can isolate a malfunctioned load 32 to prevent expansion of the short circuit incident from causing power failure for a long duration, and enhance power usage safety of the load output system 3. The primary winding 111 and secondary winding 112 of the transformer 11 are electrically isolated to isolate noises such as switching surges of power supply of the primary winding 111 without affecting normal operation of the conduction circuit 12 elements. Also referring to FIG. 2, in this embodiment, the secondary winding 112 may be coupled with a plurality of conduction circuits 12 so that after the short circuit of the power system is eliminated, setting the switch 121 of one of the conduction circuits 12 ON again to allow the equivalent internal impedance of the power supply input system 2 to return to the normal condition without affecting power supply quality.

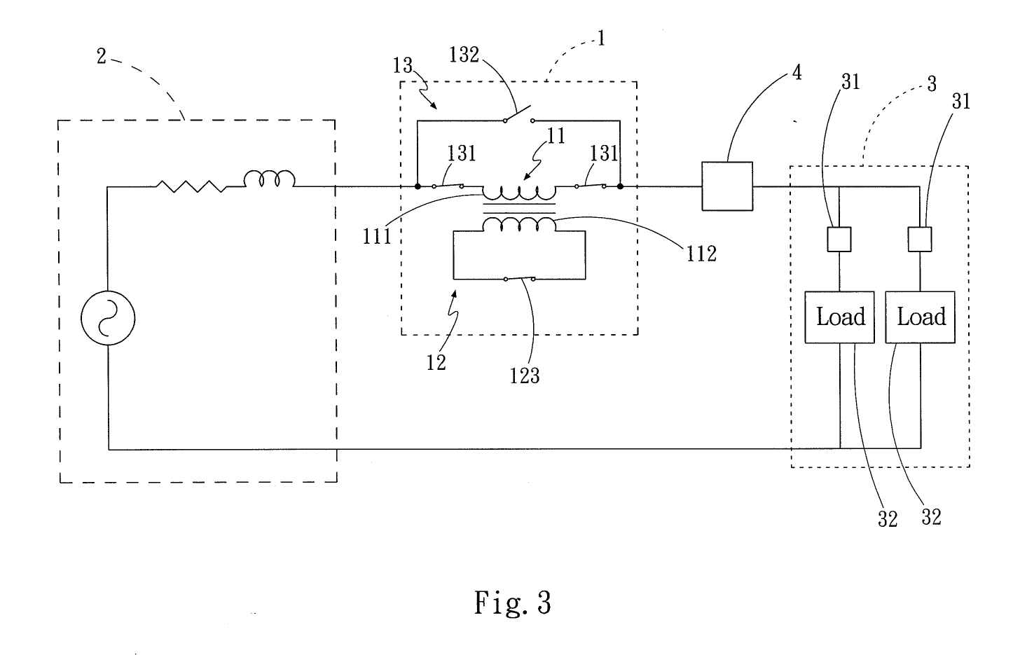

Refer to FIG. 3 for another embodiment of the invention. The conduction circuit 12 of the current regulation circuit 1 has a conduction element 123 which may be a semiconductor switch.

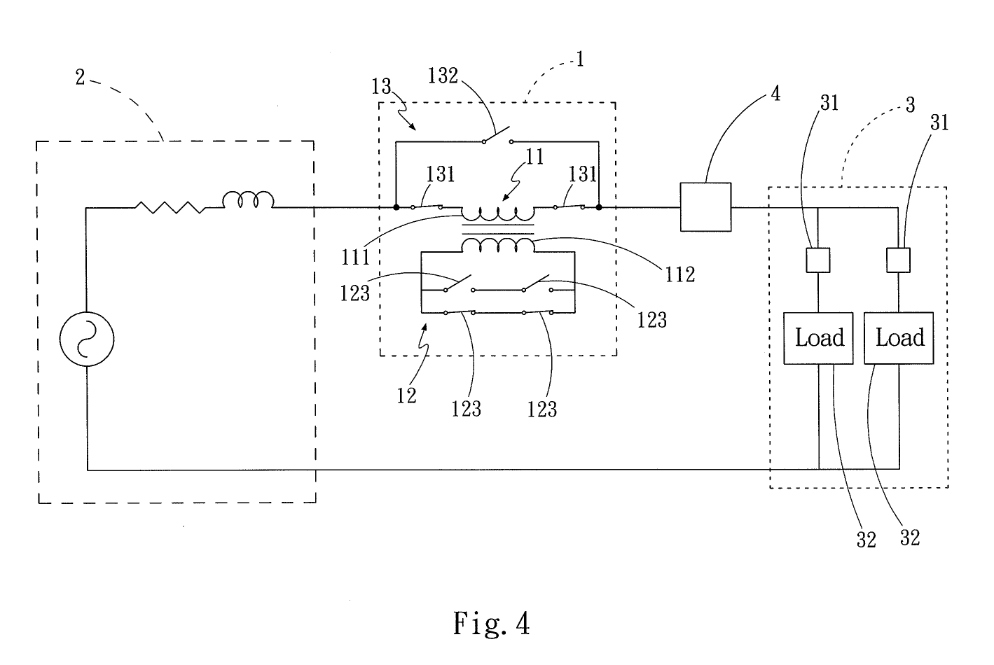

When the another embodiment is in operation, the current regulation circuit 1 detects a great current, and then sets the conduction element 123 OFF so that the secondary winding 112 becomes an open circuit, and the transformer 11 provides magnetizing reactance with high impedance to increase the equivalent internal impedance of the power supply input system 2 and limit the fault current. The circuit breaking device 4 can smoothly isolate the short circuit, and another circuit breaking device 31 in the load output system 3 can also isolate the malfunctioned load 32. After the short circuit incident is eliminated, the conduction element 123 can resume operating to allow the power system to resume supplying power. The aforesaid operation can effectively limit fault current and allow the circuit breaking devices 4 and 31 to isolate short circuit as desired and protect power supply safety of total power system. Referring to FIG. 4, in the embodiment set forth above, the conduction circuit 12 can be coupled with at least one conduction element 123 in series. Thus only one of the conduction elements 123 is set OFF can cut off the conduction state thereof. The secondary winding 112 may also be coupled with a plurality of conduction circuits 12. After the short circuit is eliminated, the conduction circuits 12 can resume operating again to avoid failure of the conduction circuits 12 caused by malfunction of a single conduction element 123.

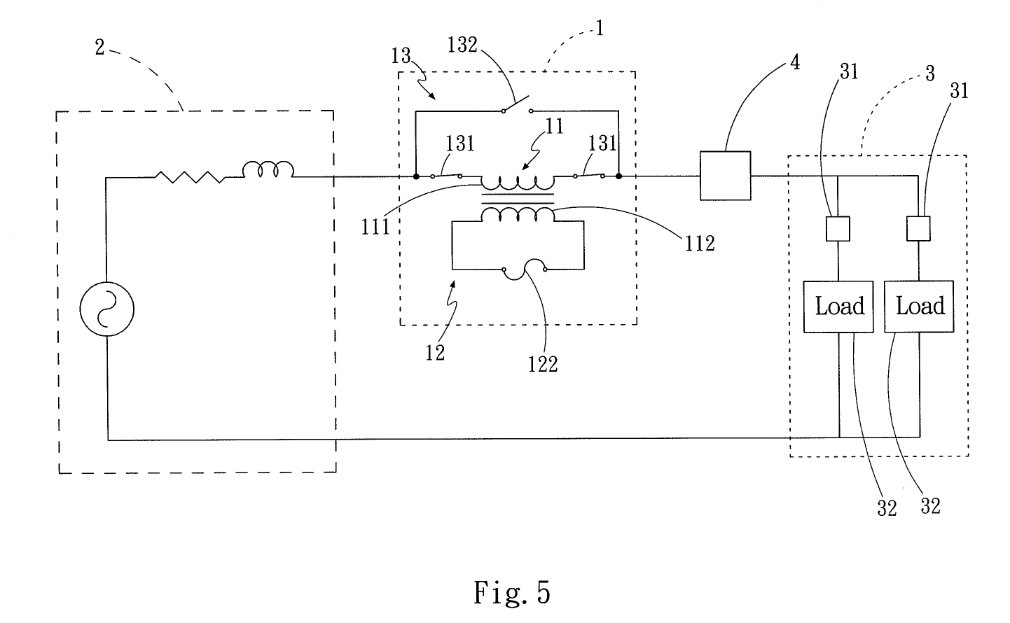

Refer to FIG. 5 for another simplified embodiment. The secondary winding 112 of the current regulation circuit 1 is coupled with at least one conduction circuit 12 which includes a breaking element 122 to provide a conduction effect. The breaking element 122 is a fuse.

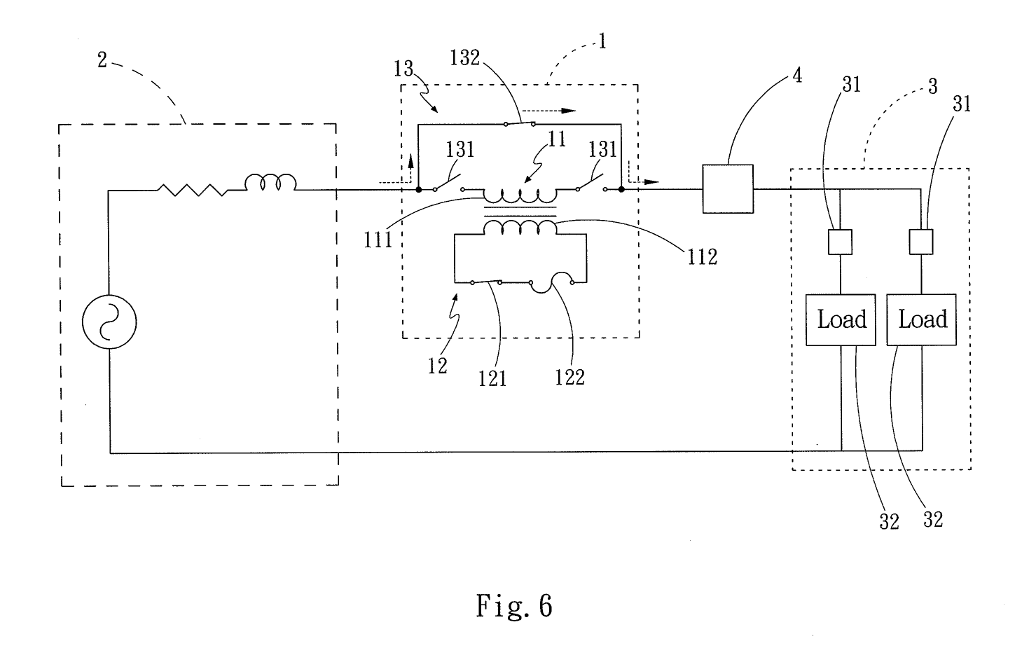

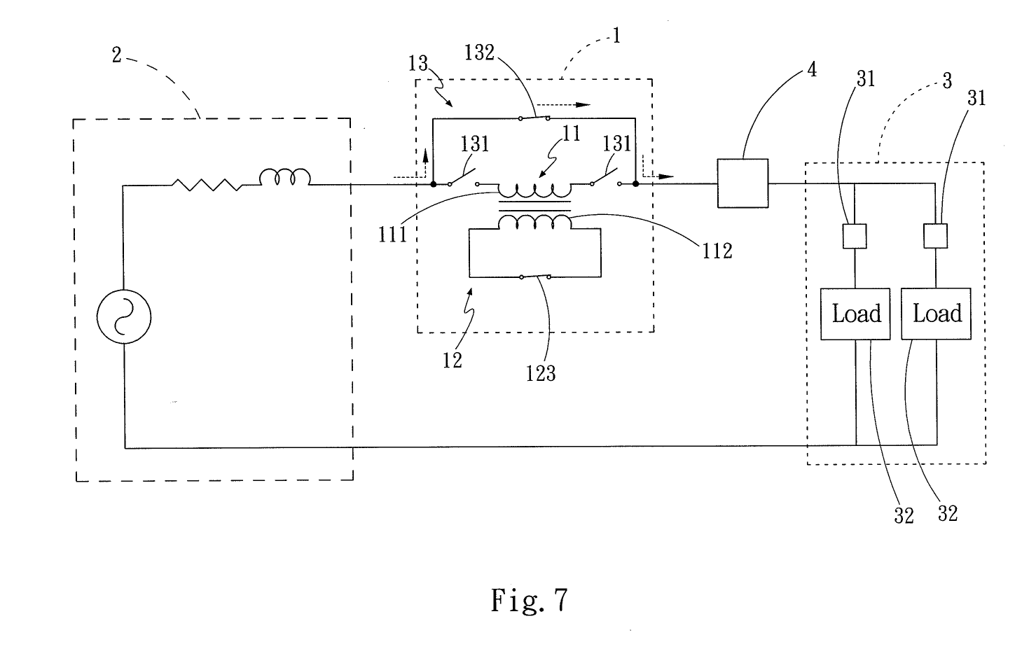

Referring to FIGS. 6 and 7, in the event that replacing a broken breaking element 122 or conduction element 123 is needed, first, set the bypass switch 132 ON to allow the power supply input system 2 to directly supply power to the load output system 3; then set the two conduction switches 131 OFF to replace the breaking element 122 or conduction element 123. After replacement of the breaking element 122 or conduction element 123 is finished, set the two conduction switches 131 ON, and then set the bypass switch 132 OFF. Thus the short circuit of the transformer 11 does not impact power usage of the load output system 3 during the replacement process of elements.

The secondary winding 112 of the transformer 11 may contain more number of windings than that of the primary winding 111, such as the voltage ratio of the secondary winding 112 and the primary winding 111 is 2:1. In the event that short circuit current on the primary winding 111 is 100 kA, the short circuit current on the secondary winding 112 is 50 kA, thus the breaking element 122 or conduction switch 123 with capacity of 50 kA may be selected to be set OFF or ON to save cost.

What is claimed is:

1. An isolation-type AC fault current limited circuit being a current regulation circuit, comprising:
a transformer which includes a primary winding and a secondary winding that share a common iron core and are electrically isolated from each other, the primary winding being coupled in series between a power supply input system and a load output system; and
at least one conduction circuit which is connected to the secondary winding and includes a switch and a breaking element coupled in series.

2. The isolation-type AC fault current limited circuit of claim 1, wherein the current regulation circuit further includes a maintenance bypass which comprises two conduction switches and a bypass switch, the two conduction switches being located respectively at a connection terminal of the primary winding and the power supply input system and at another connection terminal of the primary winding and the load output system, the bypass switch including one end connected to the power supply input system in front of one of the conduction switches and another end connected to the load output system behind the other conduction switch.

3. The isolation-type AC fault current limited circuit of claim 1, wherein the breaking element is a fuse.

4. An isolation-type AC fault current limited circuit being a current regulation circuit, comprising:
a transformer which includes a primary winding and a secondary winding that share a common iron core and are electrically isolated from each other, the primary winding being coupled in series between a power supply input system and a load output system; and
at least one conduction circuit which is connected to the secondary winding and includes at least one conduction element.

5. The isolation-type AC fault current limited circuit of claim 4, wherein the current regulation circuit further includes a maintenance bypass which comprises two conduction switches and a bypass switch, the two conduction switches being located respectively at a connection terminal of the primary winding and the power supply input system and at another connection terminal of the primary winding and the load output system, the bypass switch including one end connected to the power supply input system in front of one of the conduction switches and another end connected to the load output system behind the other conduction switch.

6. The isolation-type AC fault current limited circuit of claim 4, wherein the conduction element is a semiconductor switch.

7. The isolation-type AC fault current limited circuit of claim 4, wherein the conduction circuit includes at least one conduction element coupled in series.

8. An isolation-type AC fault current limited circuit being a current regulation circuit, comprising:
a transformer which includes a primary winding and a secondary winding that share a common iron core and are electrically isolated from each other, the primary winding being coupled in series between a power supply input system and a load output system; and
at least one conduction circuit which is connected to the secondary winding and includes a breaking element.

9. The isolation-type AC fault current limited circuit of claim 8, wherein the current regulation circuit further includes a maintenance bypass which comprises two conduction switches and a bypass switch, the two conduction switches being located respectively at a connection terminal of the primary winding and the power supply input system and at another connection terminal of the primary winding and the load output system, the bypass switch including one end connected to the power supply input system in front of one of the conduction switches and another end connected to the load output system behind the other conduction switch.

10. The isolation-type AC fault current limited circuit of claim 8, wherein the breaking element is a fuse.
